(19) United States
(12) Patent Application Publication
(10) Pub. No.: US 2004/0081269 A1
(43) Pub. Date: Apr. 29, 2004

(54) Retrospective respiratory gating for imaging and treatment

(76) Inventors: Tin-Su Pan, Brookfield, WI (US); Kishore Chandra Acharya, Brookfield, WI (US); David Caumartin, Bayside, WI (US); Dershan Luo, Brookfield, WI (US); Prathyusha K. Salla, Waukesha, WI (US)

Correspondence Address: CANTOR COLBURN, LLP, 55 GRIFFIN ROAD SOUTH, BLOOMFIELD, CT, 06002

(21) Appl. No.: 10/065,486

(22) Filed: Oct. 23, 2002

(51) Int. Cl. G21K 1/12

(52) U.S. Cl. 378/4

(57) ABSTRACT

A system for registering images using retrospective gating, the system comprising: an imaging system; an object disposed to be communicated with the imaging system, wherein the imaging system generates image data responsive to said object; and a processing device. The processing device executes a method comprising: determining a target area of interest; obtaining scout image data responsive to the target area; and processing the target area so as to create a sub-target area of interest. The method also includes computing a desired image acquisition time; operating said imaging system to create image data responsive to each sub-target area; combining the image data for each of the sub-target areas to create a set of image data; processing the image data to determine a phase of the image data; and synchronizing the image data.

### BACKGROUND OF INVENTION

This invention relates generally to a method and system for effectively registering images from an imaging system performed on the chest or abdomen or target organs that respiratory motion might compromise the image quality of the scan.

In at least one known computed tomography (CT) imaging system configuration, an x-ray source projects a fan-shaped, or a cone-shaped, beam which is collimated to lie within an X-Y-Z volume of a Cartesian coordinate system, wherein the X-Y-Z volume is generally referred to as an “imaging volume” and usually includes a set of X-Y planes generally referred to as the “imaging planes”. An array of radiation detectors, wherein each radiation detector includes a detector element, is disposed within the CT system to receive this beam. An object, such as a patient, is disposed within the imaging plane so as to be subjected to the x-ray beam wherein the x-ray beam passes through the object. As the x-ray beam passes through the object being imaged, the x-ray beam becomes attenuated before impinging upon the array of radiation detectors. The intensity of the attenuated beam radiation received at the detector array is responsive to the attenuation of the x-ray beam by the object, wherein each detector element produces a separate electrical signal responsive to the beam attenuation at the detector element location. These electrical signals are referred to as x-ray attenuation measurements.

In addition, the x-ray source and the detector array may be rotated, with a gantry within the imaging volume, around the object to be imaged so that the angle at which the x-ray beam intersects the object constantly changes. A group of x-ray attenuation measurements, i.e., projection data, from the detector array at one gantry angle is referred to as a “view”. A “scan” of the object comprises a set of views made at different gantry angles during one revolution of the x-ray source and the detector array. In an axial scan, the projection data is processed to construct an image that corresponds to two-dimensional slices taken through the object.

One method for reconstructing an image from a set of projection data is referred to as the “filtered back-projection technique”. This process converts the attenuation measurements from a scan into discrete integers, ranging from −1024 to +3072, called “CT numbers” or “Hounsfield Units” (HU). These HU's are used to control the brightness of a corresponding pixel on a cathode ray tube or a computer screen display in a manner responsive to the attenuation measurements. For example, an attenuation measurement for air may convert into an integer value of −1000HU's (corresponding to a dark pixel) and an attenuation measurement for very dense bone matter may convert into an integer value of +3000 (corresponding to a bright pixel), whereas an attenuation measurement for water may convert into an integer value of OHU's (corresponding to a gray pixel). This integer conversion, or “scoring” allows a physician or a technician to determine the density of matter based on the intensity of the computer display and thus locate and identify areas of concern.

As a patient undergoes an imaging procedure, it is essential that the patient remain still. If a patient moves during the imaging procedure, the image may be blurred and thus lack clarity. For example, when an image is taken of a patients' chest and/or diaphragm area with a helical scan procedure as the patient breathes. In this case, due to the respiratory motion of the patient, images of tumors or other areas of concern disposed within the patients' chest and/or abdomen tend to be blurred and lack clarity such that the tumor or area tends to appear larger or smaller than its actual size thus renders an inaccurate estimate of the tumor.

One problem with this occurs when the subject of the image is a tumor. When a person is diagnosed as having a tumor that requires radiation therapy, the area in which the tumor is located is exposed to a dose of radiation so as to irradiate the tumor. In order to minimize the chance of radiating normal tissue surrounding the tumor, it is necessary to locate the position of the tumor accurately. This may be accomplished by imaging the tumor and the area surrounding the tumor using an imaging device such as a computed tomography (CT) imaging system, a Flouroscope, a magnetic resonance imaging (MRI) system and/or a positron emission tomography (PET) imaging system.

Although a helical scan CT can cover the required scanning distance (20--30 cm) during a normal breathe hold, and thus completely scan the tumor during this breathe hold, the radiation therapy is a relatively long process and takes around 15 minutes. Therefore, it is not possible for a patient to hold his breathe during the therapy procedure. When a person breathes, the internal organs move by as much as several centimeters, causing the tumors to move in and out of the radiation treatment field. As a result, the respiratory motion of the patient causes the tumor to be blurred, lack clarity, distorted, and to appear larger or smaller than its actual size. Moreover, the radiation dose to the patient from the radiation therapy tends to irradiate, and thus damage, the normal tissue surrounding the tumor.

CT perfusion is another examination that requires an accurate image registration to compensate for the respiratory motion during the study. For example, during a CT liver perfusion procedure two types of image scans are typically performed, an arterial phase and a venous phase. The arterial phase of the imaging procedure normally produces images once a second for the first thirty seconds of breath hold time during which a contrast injection is administered to the patient. The venous phase of the imaging procedure is then performed and is normally measured in an interval of five to ten second intervals and may have a total image acquisition time of two to three minutes or longer. As such, because the arterial phase of the imaging procedure only takes approximately thirty seconds, a patient's holding his breath can eliminate the image artifacts due to respiratory motion. However, because the venous phase may take a couple of minutes or longer, the patient cannot hold their breath and thus the image artifacts due to respiratory motion may not be eliminated. As such, the respiratory motion of the patient causes blurring and a lack of clarity in the obtained image.

One method to address respiratory motion of a patient during imaging and application of a radiation dose is respiratory gating. The concept here is that, if movement during imaging can be tracked, an even more tightly shaped conformal dose distribution is possible and dosage to the healthy tissues can be minimized. One way this is being achieved is with respiratory gating. In retrospective respiratory gating with CT, a patient's breathing patterns are used to synchronize phases of respiratory motion with scanned images. For effective synchronization, it is necessary with respect to the selected reference point. Respiratory gating, allows therapists to track the patients respiratory cycle both at the time of the CT scan for imaging and at the time of treatment. In effect, respiratory gating facilitates isolation of the position of the target during one specific phase of the respiratory cycle, generally, during either exhale or inhale. Thus, by isolating the target position, therapists can decrease the size of the radiation fields, involve smaller amounts of normal tissue, and therefore reduce dosages.

Respiratory gating is accomplished by monitoring the patient's normal breathing pattern. For example, to deliver on exhale, every time the patient exhales, the radiation beam comes on instantly for half a second. The moment the patient starts to inhale, the radiation beam is terminated. The radiation beam is pulsed repeatedly in such a manner until the entire radiation dose has been delivered. Unfortunately, such a configuration increases the time of the treatment. However, the increased time is considered insignificant compared to the benefit of reducing the size of an applied radiation fields on a patient. Additionally, current methodologies of respiratory gating cannot identify phases of the respiratory cycle relative to the images captured.

Complementary to respiratory gating, is a method of electronic patient tracking that utilizes markers on a patient's skin surface. This method also allows for better targeting of the radiation beam. Typically, the patient may have a set of tattoos on the skin, and the therapist positions the patient, aligning them according to the tattoos. Cameras that locate and monitor the markers in 3-D space are set up in the CT and the treatment room. This tracking system localizes each marker, which allows the patent to be positioned with a greater level of accuracy. However, these systems utilize human setup and positioning and may result in the introduction of other errors in the positioning of the patient. Therefore, a method of tracking patient motion for improved imaging and treatment is needed in the art.

The above discussed and other features and advantages of the embodiments will be appreciated and understood by those skilled in the art from the following detailed description and drawings.

### SUMMARY OF INVENTION

Disclosed herein in an exemplary embodiment is a method for registering images acquired using an imaging system comprising: determining a target area of interest; obtaining scout image data responsive to the target area; and processing the target area so as to create a sub-target area of interest. The method also includes computing a desired image acquisition time; operating said imaging system to create image data responsive to each sub-target area; combining the image data for each of the sub-target areas to create a set of image data; processing the image data to determine a phase of the image data; and synchronizing the image data.

Also disclosed herein in an exemplary embodiment is a system for registering images using retrospective gating, the system comprising: an imaging system; an object disposed to be communicated with the imaging system, wherein the imaging system generates image data responsive to said object; and a processing device. The processing device executes a method comprising: determining a target area of interest; obtaining scout image data responsive to the target area; and processing the target area so as to create a sub-target area of interest. The method also includes computing a desired image acquisition time; operating said imaging system to create image data responsive to each sub-target area; combining the image data for each of the sub-target areas to create a set of image data; processing the image data to determine a phase of the image data; and synchronizing the image data.

In yet another exemplary embodiment, a storage medium encoded with a machine-readable computer program code for registering images acquired using an imaging system with respiratory gating is disclosed.

Further, disclosed herein in another exemplary embodiment is a computer data signal. The computer data signal comprising code configured to cause a controller to implement the abovementioned method for registering images acquired using an imaging system with respiratory gating.

Additionally, also disclosed is a system for registering images using retrospective gating, the system comprising a: means for determining a target area of interest; means for obtaining scout image data responsive to the target area; means for processing the target area so as to create a sub-target area of interest; means for computing a desired image acquisition time; and means for operating the imaging system to create image data responsive to each said sub-target area. The system also includes a means for combining the image data for each of the sub-target areas to create a set of image data, a means for processing the image data to determine a phase of the image data, and a means for synchronizing the image data.

Finally, disclosed in yet another exemplary embodiment is a method for assigning phases in images acquired using an imaging system comprising: operating the imaging system to create image data of an object and generate system data, wherein the system data includes object physiological information and the imaging system information corresponding to each respiratory cycle; processing the image data and said system data to determine a phase of the image data; and synchronizing the image data.

### BRIEF DESCRIPTION OF DRAWINGS

Referring to the exemplary drawings wherein like elements are numbered alike in the several Figures:

FIG. 1 is a perspective view of a CT imaging system and a patient disposed for imaging;

FIG. 2 is a block schematic diagram of a CT imaging system;

FIG. 3 is a flow chart depicting a method for registering images from an imaging system using respiratory gating in accordance with a first embodiment;

FIG. 4 is a diagram depicting several respiratory cycles;

FIG. 5 represents selecting a particular phase selected during the respiratory cycle used to reconstruct an image at that phase;

FIG. 6 a generalized block diagram depicting a simplified portion the imaging system 1 for respiratory gating;

FIG. 7 is a diagram depicting a respiratory waveform and phase in accordance with an alternative embodiment; and

FIG. 8 is a flow chart depicting a method for registering images from an imaging system using respiratory gating in accordance with an alternative embodiment.

### DETAILED DESCRIPTION

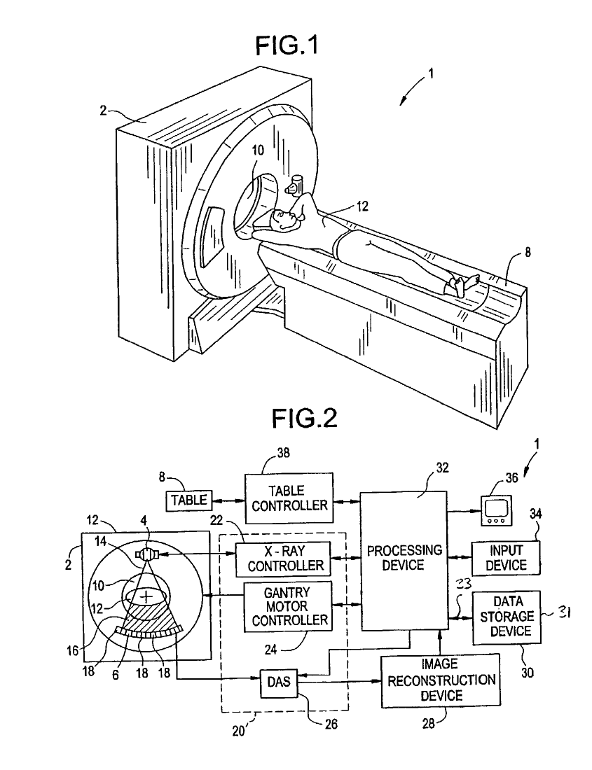

Referring to FIG. 1 and FIG. 2 a representative CT imaging system 1 is shown and includes, but is not limited to, a gantry 2 having an x-ray source 4, a radiation detector array 6, a patient support structure 8 and a patient cavity 10, wherein x-ray source 4 and radiation detector array 6 are opposingly disposed so as to be separated by patient cavity 10. A patient 12 may be disposed upon patient support structure 8, which is then disposed within patient cavity 10. X-ray source 4 projects a x-ray beam 14radiation beam 14 toward radiation detector array 6 so as to pass through patient 12. Radiation beam 14 may be collimated by a collimate (not shown) so as to lie within an X-Y-Z volume of a Cartesian coordinate system referred to as an “imaging volume”. After passing through and becoming attenuated by patient 12, attenuated x-ray beam 16 is received by radiation detector array 6. Radiation detector array 6 includes, but is not limited to a plurality of detector elements 18 wherein each of the detector elements 18 receives attenuated x-ray beam 16 and produces an electrical signal responsive to the intensity of attenuated x-ray beam 16.

In addition, x-ray source 4 and radiation detector array 6 are rotatingly disposed relative to gantry 2 and patient support structure 8, so as to allow x-ray source 4 and radiation detector array 6 to rotate around patient support structure 8 when patient support structure 8 is disposed within patient cavity 10. X-ray projection data is obtained by rotating x-ray source 4 and radiation detector array 6 around patient 10 during a scan. X-ray source 4 and radiation detector array 6 may be communicated with a control mechanism 20 associated with CT imaging system 1.

Control mechanism 20 controls the rotation and operation of x-ray source 4 and/or radiation detector array 6. Control mechanism 20 includes, but is not limited to, an x-ray controller 22 communicated with x-ray source 4, a gantry motor controller 24, and a data acquisition system (DAS) 26 communicated with radiation detector array 6, wherein x-ray controller 22 provides power and timing signals to x-ray source 4, gantry motor controller 24 controls the rotational speed and angular position of x-ray source 4 and radiation detector array 6 and DAS 26 receives the electrical signal data produced by detector elements 18 and converts this data into digital signals for subsequent processing. CT imaging system 1 may also include an image reconstruction device 28, a data storage device 30 and a processing device 32, wherein processing device 32 is communicated with image reconstruction device 28, gantry motor controller 24, x-ray controller 22, data storage device 30, an input device 34 and an output device 36. Moreover, CT imaging system 1 may also includes a table controller 38 communicated with processing device 32 and patient support structure 8, so as to control the position of patient support structure 8 relative to patient cavity 10.

Although the embodiments described herein are described as applying to a computed tomography imaging system 1, it should be stated that the embodiments described herein may be applied to any imaging system and radiation treatment system suitable to the desired end purpose, such as an imaging or treatment system where any expected physiological characteristic impacts the imaging/treatment results. For example, the embodiments disclosed herein may be applicable to x-ray, computed tomography, magnetic resonance imaging, radiation therapy, and the like, as well as combinations including at least one of the foregoing. Physiological characteristics as identified above may include, but not be limited to motion of the patient, motion of an organ, cardiac motion, respiratory motion, and the like, as well as combinations including at least one of the foregoing.

In accordance with an exemplary embodiment, patient 12 is disposed on patient support structure 8, which is then positioned by an operator via processing device 32 to be disposed within patient cavity 10. Gantry motor controller 24 is operated via processing device 32 to cause x-ray source 4 and radiation detector array 6 to rotate relative to patient 12. X-ray controller 22 is operated via processing device 32 so as to cause x-ray source 4 to emit and project a collimated x-ray beam 14radiation beam 14 toward radiation detector array 6 and hence toward patient 12. X-ray beam 14Radiation beam 14 passes through patient 12 so as to create an attenuated x-ray beam 16, which is received by radiation detector array 6.

Detector elements 18 receive attenuated x-ray beam 16, produces electrical signal data responsive to the intensity of attenuated x-ray beam 16 and communicates this electrical signal data to data acquisition system (DAS) 26. DAS 26 then converts this electrical signal data to digital signals and communicates both the digital signals and the electrical signal data to image reconstruction device 28, which performs high-speed image reconstruction. This information is then communicated to processing device 32, which stores the image in data storage device 30 and displays the digital signal as an image via output device 36.

To obtain images/apply radiation therapy (e.g., images of tumors), patients are asked to breath normally or couched to breath in a regular pattern. Patients are scanned employing standard axial scanning protocol. Other scanning protocols are possible, an axial scan is discussed here for illustrative purposes. Scan duration is selected as the period of maximum respiratory cycle of the patient 40 plus rotation time of the scanner gantry 2. Once the scanning is complete, the table 8 and thereby the patient 12 is translated by a distance equal to the number of detectors 18 times the width of each detector 18. For example, for a scanner with 8 detectors and of width 2.5 mm, the table 8 is translated by 20 mm. The axial scan is resumed in the new position and the imaging/translation process is repeated until the entire region of interest e.g., organ is covered. Separate equipment may be employed to monitor and record patient breathing/respiratory cycle 40 and state of the X-ray signal i.e. the on and off states.

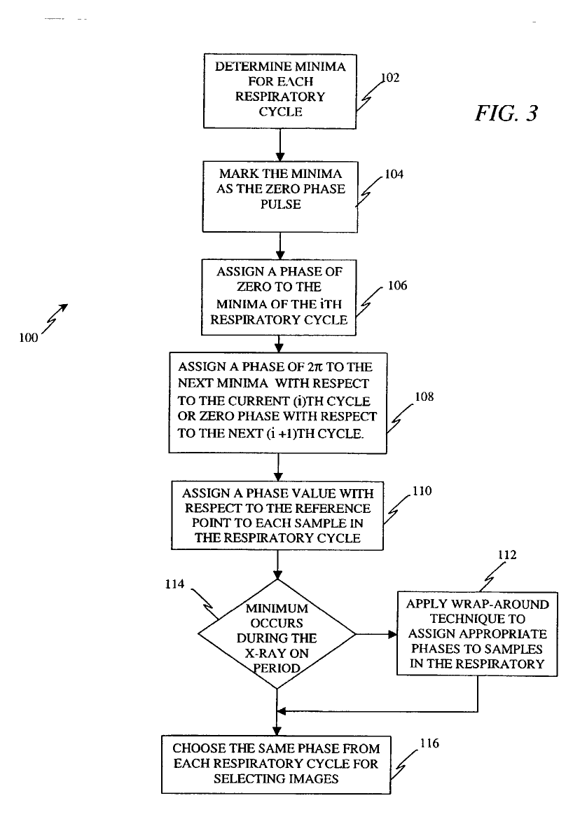

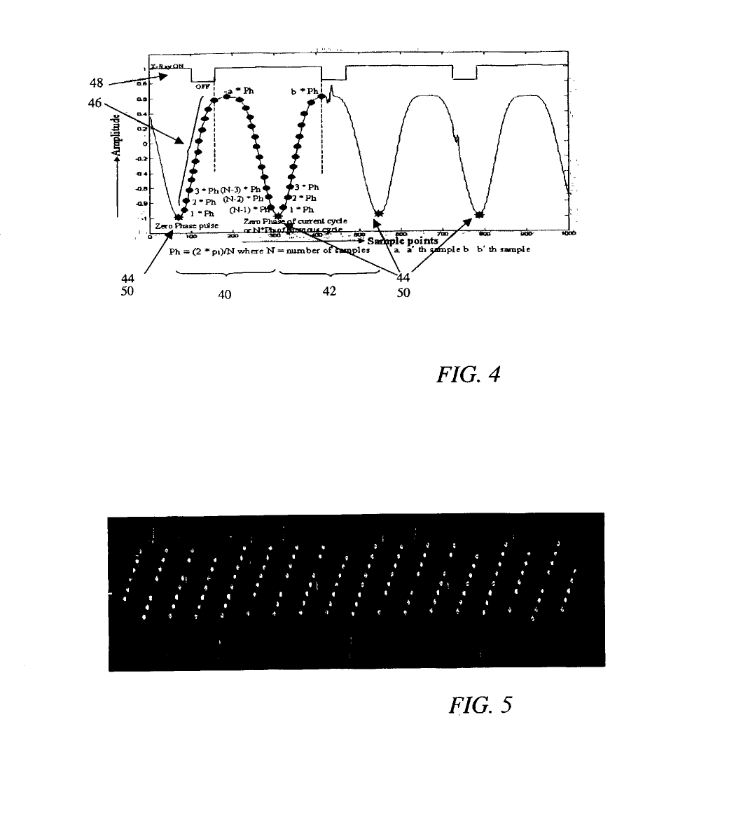

Referring to FIG. 3, a flow chart depicting an exemplary method 100 is provided for synchronizing images of a patient 12, obtained via an imaging system 1, using respiratory gating in accordance with a first embodiment is shown and discussed. As stated earlier, for retrospective respiratory gating, the scanned images are synchronized with selected phases of a particular physiological characteristic, namely, in this embodiment, a respiratory cycle 40 to compensate for respiratory motion. It will be appreciated that while the physiological characteristic disclosed herein is a respiratory cycle, without a loss of generality, numerous variations are possible. Respiratory cycle as used herein is for illustrative purposes. For effective synchronization, it is necessary to define a reference point 50 in every respiratory cycle 40 and quantify each phase with respect to the reference point 50. While current methodologies include some breathing phase estimation and synchronization, these methodologies are inaccurate for the first few seconds of data acquisition. Discloses herein is a methodology for assigning phases in the respiratory cycle 40 for retrospective respiratory gating that overcomes this limitation and addresses some of the issues presented by internal organ movement as it relates to a patient's respiration for imaging and treatment.

In retrospective respiratory gating, images are acquired while the patient is breathing normally and the breathing rhythm is recorded simultaneously with the image data. For synchronization purposes, a reference point 50 is selected. The reference point 50 may be selected as one of either, a minimum or a maximum in each respiratory cycle 40 based on the application. The algorithm outlined herein is used to assign phases to data points in the respiratory cycle with respect to a selected reference point. A minimum is used here for illustrative purposes, other points in the respiratory cycle 40 may be employed for each respiratory cycle. Continuing with FIG. 3 and referring now to FIG. 4, a depiction of several respiratory cycles 40 is provided. Method 100 initiates at process block 102, where the minima 44 for the total data are determined retrospectively based on prior knowledge of the respiratory cycle duration. Turning to process block 104, the minima 44 determined above are marked as the reference points 50 of the respiratory cycle 40 also denoted ZERO PHASE pulse herein and in the figures. Turning to process block 106, the minimum of the ith respiratory cycle 40 is assigned a phase of zero. Furthermore, at process block 108, the next minimum is assigned a phase of 2 p with respect to the current (i)th respiratory cycle 40 or zero phase with respect to the next (i+1)th respiratory cycle 42. At process block 110, each sample 46 in the respiratory cycle 40, 42 is assigned a phase value with respect to the reference point 50. For instance, if there are ‘N’ samples between the zero phase and 2p points of a respiratory cycle 40, 42, each sample is assigned a phase of Ph=(2 *p * n )/N (where n=1, 2,3 . . . N samples).

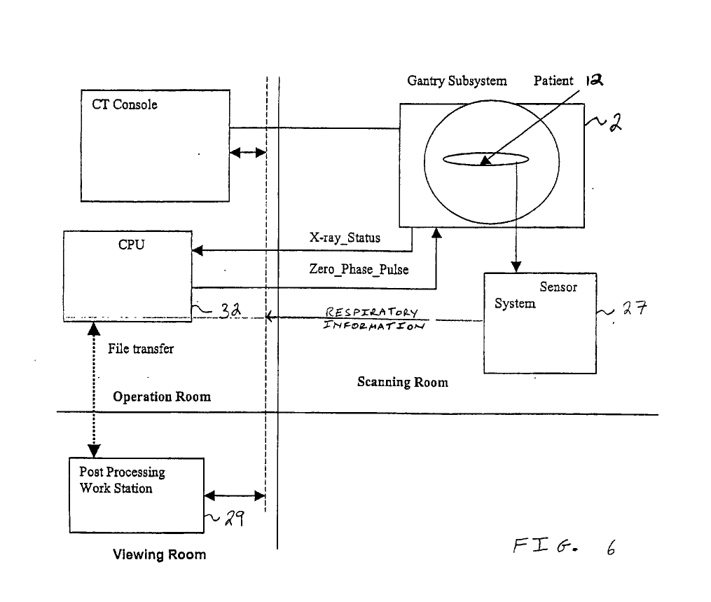

Continuing now to decision block 112, if the minimum occurs during the X-ray radiation beam ON period 48, the method 100 transitions to a wrap-around technique employed at process block 114 to assign the appropriate phases to samples 46 in the respiratory cycle 40, 42 e.g., all the samples 46 prior to the minimum are assigned a phase value (2 p minus a positive phase) till they reach the minimum in the previous respiratory cycle e.g., 40, 42. Thus, a single respiratory cycle 40, 42 will have all possible phases for selecting an image. Thereafter, as depicted at process block 116, the same phase from each respiratory cycle e.g., 40, 42 is utilized for selecting images. FIG. 5 represents selecting a particular phase selected during the respiratory cycle e.g., 40, 42 used to reconstruct an image at that phase.

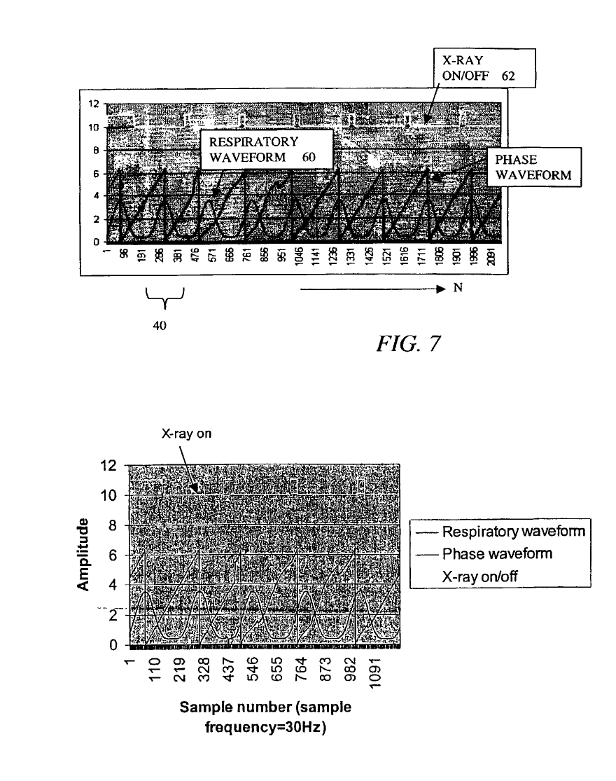

In an alternative embodiment, another methodology for retrospective respiratory gating is disclosed. Referring to FIGS. 1 and 6, a generalized block diagram depicting a simplified portion an imaging system such as imaging system 1 for respiratory gating. In this embodiment, the CT imaging system 1 may be supplemented with a system Referring now to FIG. 7 in addition to FIGS. 1 and 6 to facilitate execution of the respiratory gating, a respiratory cycle 40 is divided into N substantially equal parts. Each part corresponds to a specific respiratory phase of the respiratory cycle 40. Images are generated/acquired at time interval t=T/N (where T is the period (time duration) of the respiratory cycle 40). This process is substantially similar to that described in the abovementioned embodiment and therefore only distinctions are addressed here for clarity. The patient's respiratory waveform 60, e.g., a signal indicative of the patient's respiratory cycles, the state of the X-ray signal 62 and images are post processed utilizing an image post processing work station 29, or the like, and sorted based upon a selected/assigned phase and spatial position. More specifically, for each detector 18 position, a temporal bin (e.g., storage location(s)) comprising N slots is generated and every image is assigned a slot based upon its phase and spatial position for that detector position. The phase of each image is determined with respect to the respiratory waveform 60. Zero phase may be defined either as the maximum point or the minimum point of the respiratory waveform 60. It will be appreciated that while a maximum or minimum is selected for ease of illustration, a zero phase point may be defined for any point along the respiratory waveform 60. Similar to the above embodiment, a minimum is selected for illustration purposes. The state of the X-ray signal is used to synchronize the respiratory waveform 60 with captured images. Respiratory waveforms 60 or portions thereof recorded during X-ray off states (non-radiating) are not used for determining the phase of images. The phases of respiratory waveform need to be determined (zero phase, etc). However, only the phases corresponding to the images will be used. In this manner, phase associated with non-imaged data are avoided.

In an exemplary embodiment, a zero phase pulse is generated by an external sensor system 27 responsive to the patient's respiratory cycle 40 and is sent to the scanner. This signal, denoted a zero-phase pulse, gates, e.g., initiates, the generation of the radiation beam 14 and scanning data acquisition. The X-ray on state and scanning data acquisition continues until the receipt of the next zero-phase pulse. Advantageously, this embodiment accounts for random fluctuation of the period of the respiratory cycle 40 and thereby, reduces the dose to the patient and scanning time by eliminating the need of keeping radiation beam 14 on for durations in excess of the respiratory cycle 40. Moreover, the phase information may readily be stored with the images simplifying the sorting process as may be executed by the post processing workstation 29. Additionally, respiratory gating facilitates the visualization of a target (e.g., tumor) at different points in the respiratory cycle, allowing an operator the opportunity to select those respiratory phases where the tumor motion is minimal. Another significant advantage of respiratory gating is that the need for breath hold imaging is reduced. The images are now instead “compensated” for the motion accordingly. Storing the respective phase information with the acquired image data eliminates the need for acquiring/storing the information for the respiratory waveform 60 and/or the state of the X-ray signal during the sorting of images by phase and spatial position.

Yet another embodiment may be considered, which provides an enhancement to the imaging of a patient including respiratory gating, is the scanning of the patient in a helical (spiral) mode instead of the axial mode as discussed above. Employing a helical scan coupled with respiratory gating reduces the total scan duration and dosage delivered to the patient. It will be appreciated however, that since the period of the respiratory cycle is long, e.g., seconds, and the pitch for the helical scan must be kept relatively small. For example, a helical scan pitch on the order of about less than or equal to 1.0 is preferred.

In yet another embodiment as disclosed herein, a method that accelerates the imaging process and reduces the dosage administered to the patient. In this embodiment, a method is employed where 20 to 30 cm of the target area is covered by performing a fast low dose helical scan without using gating. This helical scan is utilized to localize the target region and more accurately identify the target. Thereafter, a respiratory-gated scan can be performed on the target area for improved imaging and reduced dosage.

In yet another exemplary embodiment, an enhancement to the imaging of a patient may be achieved with a cine acquisition mode (detector parked at the same location for data acquisition) with or without gating of the respiratory information. In this embodiment, each acquisition covers a complete respiratory cycle 40 plus a reconstruction window. The reconstruction window is equivalent to the time duration for ⅔ of a complete gantry 2 rotation time or one complete gantry 2 rotation time, depending on the reconstruction of either half or full scan reconstructions respectively. It will be appreciated that existing CT imaging is often performed utilizing either a 180 degree plus fan angle of detector or 360 degree scan corresponding to half plus fan and full gantry rotations. A series of acquisitions is made to cover the area of interest. The additional reconstruction window ensures that all the phases of a complete breathing/respiratory cycle 40 will be represented in the series of images reconstructed with spacing of a Δt<<⅔ (or 1) complete gantry rotation cycle. For example, without loss of generality, it will be appreciated that existing CT systems exhibit a gantry rotation time of about 0.5 sec. In this instance, for example, the required acquisition time will therefore be the duration of one respiratory cycle 40 plus 0.33 or 0.5 sec. for half or full scan reconstructions, respectively. If respiratory information e.g., a respiratory waveform 60 (FIG. 7) was collected and synchronized with the reconstructed images, it will be appreciated that it is now conceivable to register the images of the same phase across multiple cine acquisition locations to generate all phases of two-dimensional (2D) images across multiple locations. Moreover, and significantly, it will be appreciated that four-dimensional (4D) images (i.e., three-dimensional (3D) data plus time) may be generated. Uniquely, if no respiratory information is collected to supplement the image reconstruction, post-processing may be employed to register the images of the same phases across the images taken at different respiratory cycles 40. The post processing would involve measurements in an ROI (region of interest) at locations sensitive to the breathing motion, such as, for example, the liver and lung interface or the outer surface of the abdomen, to estimate the phases of the respiratory motion cycle, and utilizing the measurement information to register the images of the same phases across the images taken at different respiratory cycles 40. For example, The phase information my be derived by placing a region of interest on an organ related to respiratory motion, e.g., rib cage, or liver, to obtain the images. The sum of the images in the region of interest would indicate the phases of breathing.

Advantageously, this approach provides a means of utilizing a step-and-shoot acquisition mode at multiple locations retrospectively, facilitating the generation of same phase images as if the image data were acquired employing a large detector. Therefore, it provides a means for the CT lung/liver perfusion imaging and PET attenuation correction with or without respiratory gating. CT images may be utilized for attenuation correction of the PET images and thereby facilitating enhance PET imaging. To further improve the results, if PET images are captured utilizing a gating scheme, the CT images are preferably gated as well.

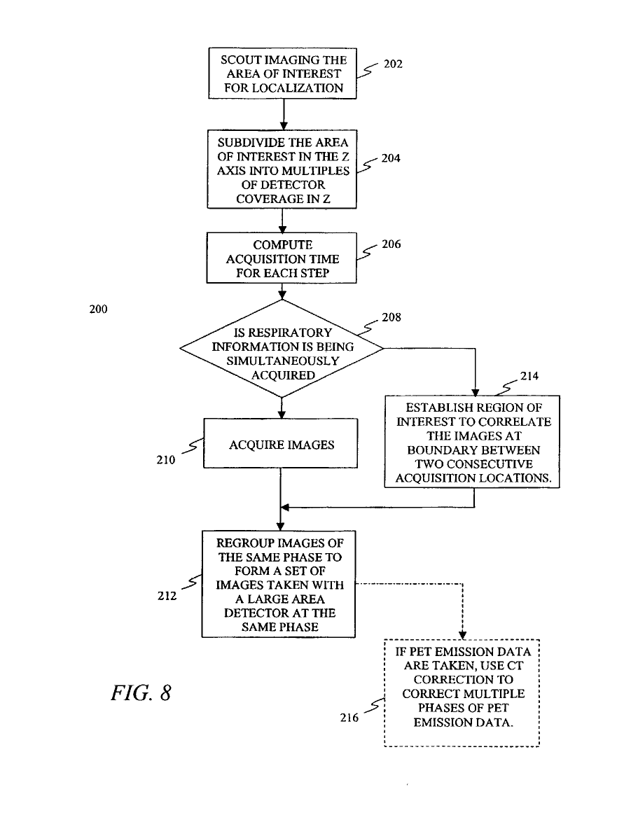

To illustrate an exemplary embodiment as disclosed, reference may be made to FIG. 8. FIG. 8 is a flow chart depicting a process 200 for 4D imaging with respiratory gating. The process 200 initiates with process block 202 and scouting the imaging the area of interest for localization. In an exemplary embodiment the CT imaging is performed at one angle. Optionally it may be performed at two angles of 90 degrees apart.

Knowing the area of interest, at process block 204 the area of interest is subdivided in the Z-axis (in this embodiment the patient table direction) into multiples of detector coverage in Z. For example, if there is 6cm of the area of interest in the Z direction, and the detector coverage in that axis is only 2 cm, data is acquired with—−3 consecutive locations, with each location covering 2 cm. At process block 206, the acquisition time at each step is computed. The acquisition time will be at least one complete breathing cycle (can be estimated with how many breathing cycles the patient went through per minute before the cine acquisition at each step) plus the reconstruction window of either ⅔ or one complete gantry rotation cycle.

Continuing with FIG. 8, during acquisition, it is desirable to also simultaneously acquire the respiratory information e.g., the respiratory waveform 60 so that registration of images at the same phase may be accomplished with recorded respiratory information. At decision block 208, a determination as to whether respiratory information is also being acquired is made. If so, the process transfers to block 210 to acquire the images. However, once again, it will be appreciated that, it is not necessary to acquire respiratory information. If at decision block 208 is determined that respiratory information will not be acquired, the process 200 transitions to process block 214 where additional processing is performed to correlate the images. By employing an acquisition time longer than a complete breathing/respiratory cycle 40, the images may be registered without respiratory gating by either drawing a region of interest to measure the change of sum of CT numbers in the area of lung/liver interface or by correlating the images at a boundary between two consecutive acquisition locations. For example, in an n-slice CT system, the image of an nth row detector and the image of the first row detector at two consecutive step-and-shoot steps of data acquisition may be correlated to register the images of the same phase in a breathing cycle. One approach is to simultaneously showing two images at adjacent locations side by side, with one dial to allow user to skim through all the phases/images at one location relative to a selected image at adjacent location. Some quantitative measures of boundary of organs can be provided to facilitate the comparison and selection. The spacing between images in each step is selected to be much smaller than the breathing cycle (normally 3 to 6 secs). For example, in an exemplary embodiment, a spacing of 0.1 to 1 sec may be selected.

Returning to FIG. 8 and process block 212 to complete the imaging process and reconstruction, the images of the same phase are regrouped to become a set of images taken with a large area detector at the same phase.

Optionally, in an alternative embodiment, if PET emission data are also taken without gating, the combined CT images at the same location from multiple phases may be used for attenuation correction so that the temporal resolution of CT images matches the temporal resolution of PET images. Temporal resolution matching is an important step of PET imaging with CT based attenuation correction. Similarly, if the PET emission data are acquired with respiratory gating, then the multiple phases of CT images may readily be utilized to provide attenuation-correction of the multiple phases of PET emission data. Process block 216 illustrates this alternative.

The disclosed invention may be embodied in the form of computer or controller implemented processes and apparatuses for practicing those processes. The present invention can also be embodied in the form of computer program code containing instructions embodied in tangible media, such as floppy diskettes, CD-ROMs, hard drives, or any other computer-readable storage medium 31 (FIG. 2), wherein, when the computer program code is loaded into and executed by a computer or controller, the computer becomes an apparatus for practicing the invention. The present invention may also be embodied in the form of computer program code or signal 33 (FIG. 2), for example, whether stored in a storage medium 31 (FIG. 2), loaded into and/or executed by a computer or controller, e.g. processing device, 32 (FIG. 2), or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for registering images acquired using an imaging system comprising:
determining a target area of interest;
obtaining scout image data responsive to said target area;
processing said target area so as to create a sub-target area of interest;
computing a desired image acquisition time;
operating said imaging system to create image data responsive to each said sub-target area;
combining said image data for each of said sub-target areas to create a set of image data;
processing said image data to determine a phase of said image data; and
synchronizing said image data.

2. The method of claim 1 wherein said sub-target area corresponds to a size of a detector in a selected axis.

3. The method of claim 1 wherein said target area of interest corresponds to a size of a target.

4. The method of claim 1 wherein said set of image data corresponds to said target area of interest.

5. The method of claim 1 further comprising said operating includes establishing an acquisition time for said image data corresponding to a physiological cycle plus at least one of two thirds of a gantry rotation time and one gantry rotation time.

6. The method of claim 1, wherein said target area of interest is associated with an object to be imaged.

7. The method of claim 1 wherein said synchronizing includes utilizing said phase to correlate image data.

8. The method of claim 1 further comprising synchronizing PET emission data utilizing said phase.

9. A system for registering images using retrospective gating, the system comprising:
an imaging system;
an object disposed so as to be communicated with said imaging system, wherein said imaging system generates image data responsive to said object; and
a processing device, wherein said processing device executes a method comprising:
determining a target area of interest;
obtaining scout image data responsive to said target area;
processing said target area so as to create a sub-target area of interest;
computing a desired image acquisition time;
operating the imaging system so as to create image data responsive to each said sub-target area;
combining said image data for each of said sub-target areas to create a set of image data;
processing said image data to determine a phase of said image data; and
synchronizing said image data.

10. The system of claim 9 wherein said sub-target area corresponds to a size of a detector in a selected axis.

11. The system of claim 9 wherein said target area of interest corresponds to a size of a target.

12. The system of claim 9 wherein said set of image data corresponds to said target area of interest.

13. The method of claim 9, wherein said target area of interest is associated with an object to be imaged.

14. The method of claim 9 wherein said synchronizing includes utilizing said phase to correlate image data.

15. A storage medium encoded with a machine-readable computer program code for registering images acquired using an imaging system with respiratory gating, said medium including instructions for causing controller to implement a method comprising:
determining a target area of interest;
obtaining scout image data responsive to said target area;
processing said target area so as to create a sub-target areas of interest;
computing a desired image acquisition time;
operating the imaging system to create image data responsive to each of said sub-target areas;
combining said image data for each of said sub-target areas so as to create a set of image data;
processing said image data to determine a phase of said image data; and
synchronizing said image data.

16. The storage medium of claim 15 further comprising computer program code wherein said operating includes establishing an acquisition time for said image data corresponding to a physiological cycle plus at least one of two thirds of a gantry rotation time and one gantry rotation time.

17. The storage medium of claim 15 further comprising computer program code wherein said method further includes:
synchronizing PET emission data utilizing said phase.

18. A computer data signal, said computer data signal comprising code configured to cause a controller to implement a method for registering images acquired using an imaging system with respiratory gating, the method comprising:
determining a target area of interest;
obtaining scout image data responsive to said target area;
processing said target area so as to create a sub-target areas of interest;
computing a desired image acquisition time;
operating the imaging system to create image data responsive to each of said sub-target areas;
combining said image data for each of said sub-target areas so as to create a set of image data; processing said image data to determine a phase of said image data; and
synchronizing said image data.

19. The computer data signal of claim 18 further comprising computer program code wherein said operating includes establishing an acquisition time for said image data corresponding to a physiological cycle plus at least one of two thirds of a gantry rotation time and one gantry rotation time.

20. The computer data signal of claim 18 further comprising computer program code wherein said method further includes:
synchronizing PET emission data utilizing said phase.

21. A system for registering images using retrospective gating, the system comprising a:
means for determining a target area of interest;
means for obtaining scout image data responsive to said target area;
means for processing said target area so as to create a sub-target area of interest;
means for computing a desired image acquisition time;
means for operating said imaging system to create image data responsive to each said sub-target area;
means for combining said image data for each of said sub-target areas to create a set of image data;
means for processing said image data to determine a phase of said image data; and
means for synchronizing said image data.

22. The system of claim 21 further comprising said means for operating including means for establishing an acquisition time for said image data corresponding to a physiological cycle plus at least one of two thirds of a gantry rotation time and one gantry rotation time.

23. The system of claim 21 further comprising:
means for synchronizing PET emission data utilizing said phase.

24. A method for assigning phases in images acquired using an imaging system comprising:
operating said imaging system to create image data of an object and generate system data, wherein said system data includes object physiological information and imaging system information corresponding to each respiratory cycle;
processing said image data and said system data to determine a phase of said image data; and
synchronizing said image data.

25. The method of claim 24 further including:
determining a reference point in said system data;
establishing said reference point as a zero phase;
assign a phase of zero to an ith reference point of said system data and assigning 2 pi phase for each subsequent cycle; and
wherein said synchronizing includes selecting images with correlating phase.

26. The method of claim 24 wherein said system data includes physiological data.

27. The method of claim 26 wherein said physiological data includes respiratory cycle data.

28. The method of claim 25 further including applying a wrap around technique to adjust said phase if said reference point occurs while said imaging system is not imaging.
